(19) United States
(12) Patent Application Publication
(10) Pub. No.: US 2018/0237260 A1
(43) Pub. Date: Aug. 23, 2018

(54) ELEVATOR SAFETY SYSTEM AND METHOD OF MONITORING AN ELEVATOR SYSTEM

(71) Applicant: Otis Elevator Company, Framington, CT (US)

(72) Inventors: Peter Herkel, Berlin (DE); Dirk H. Tegtmeier, Berlin (DE)

(21) Appl. No.: 15/901,005

(22) Filed: Feb. 21, 2018

(30) Foreign Application Priority Data
Feb. 22, 2017 (EP) 17157409.8

(51) Int. Cl. B66B 5/00; B66B 1/34; B66B 9/00

(52) U.S. Cl. CPC B66B 5/0031; B66B 1/3492; B66B 9/00; B66B 5/0056; B66B 1/3407

(57) ABSTRACT

An elevator safety system for an elevator system (2) with an elevator car (12), which is movable along a hoistway (4), comprises: at least one position sensor (25), which is configured for determining a position value representing the position of the elevator car (12) within the hoistway (4); a limit setting unit (32), which is configured for determining an operation status of the elevator system (2) and for setting at least one position limit according to the determined operation status of the elevator system (2); and a comparison unit (34), which is configured for comparing the position value with the position limit and for determining an unsafe condition of the elevator system (2) if the position value is not in compliance with the at least one position limit.

The present invention relates to an elevator safety system and to a method of monitoring an elevator system.

Elevator systems usually comprise an elevator safety system which is configured for monitoring and checking the operation of the elevator system in order to stop any further operation of the elevator system, in particular any movement of the elevator car, in case an unsafe condition of the elevator system occurs.

Unsafe conditions of the elevator system in particular may include situations in which a person, in particular a mechanic, enters the hoistway for maintaining and/or repairing the elevator system.

It therefore would be beneficial to provide an elevator safety system which reliably ensures the safety of a person working within the hoistway. It is further desirable that the elevator safety system does not restrict the operation of the elevator system more than necessary and that it can be operated easily and conveniently.

Exemplary embodiments of the invention include an elevator safety system for an elevator system comprising an elevator car, which is movable along a hoistway, wherein the elevator safety system comprises: at least one position sensor, which is configured for determining a position value representing the position of the elevator car within the hoistway; a limit setting unit, which is configured for determining an operation status of the elevator system and for setting at least one position limit according to the determined operation status of the elevator system; and a comparison unit, which is configured for comparing the position value with the position limit and for determining an unsafe condition of the elevator system if the position value is not in compliance with the at least one position limit.

Exemplary embodiments of the invention further include an elevator system comprising an elevator car, which is movable along a hoistway, and an elevator safety system according to an exemplary embodiment of the invention.

According to an exemplary embodiment of the invention, a method of monitoring an elevator system having an elevator car, which is movable along a hoistway, includes: determining the operation status of the elevator system and setting at least one upper or lower position limit as a function of the operation status of the elevator system; determining a position value representing the position of the elevator car within the hoistway; comparing the determined position value with the position limit; and determining an unsafe condition of the elevator system, if the position value exceeds at least one upper position limit or undercuts at least one lower position limit.

Exemplary embodiments of the invention allow for setting upper and/or lower limits for the position of the elevator car according to actual needs, in particular in correspondence with the determined operation status of the elevator system. Thus, exemplary embodiments of the invention reliably ensure the safety of a person working within the hoistway without restricting the operation of the elevator system more than necessary. The upper and/or lower limits for the position of the elevator car can be set automatically in correspondence with the determined operation status of the elevator system. Therefore, the use and operation of the elevator safety system is easy and convenient and the risk of faulty operation is considerably reduced.

Exemplary embodiments of the invention are described in the following with respect to the enclosed figures.

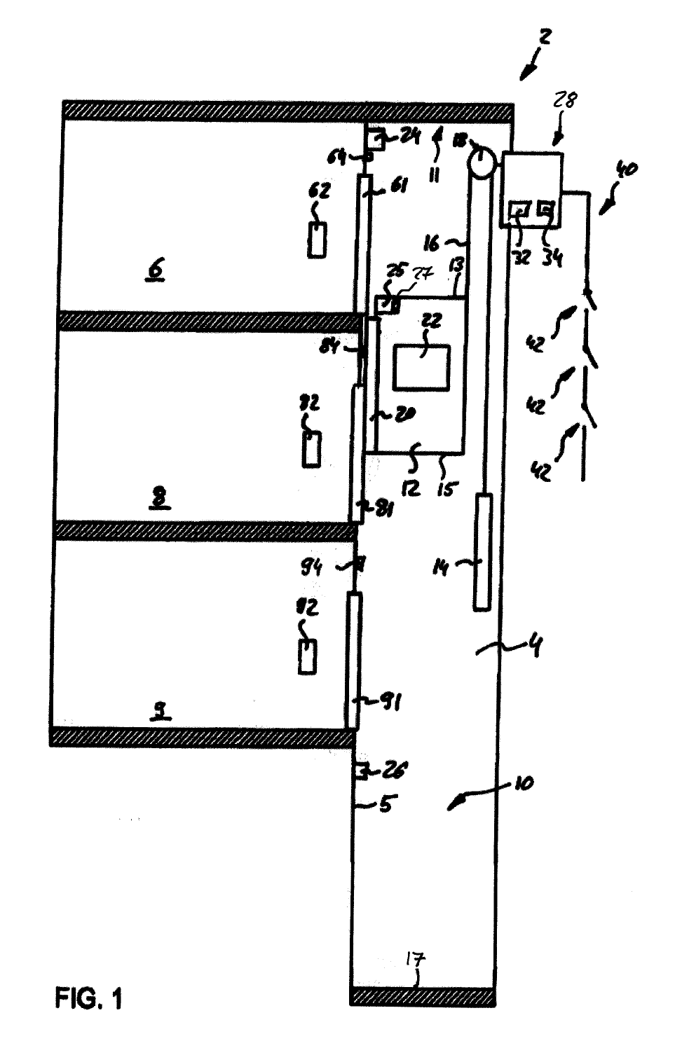

FIG. 1 shows a schematic view of an elevator system according to an exemplary embodiment of the invention;

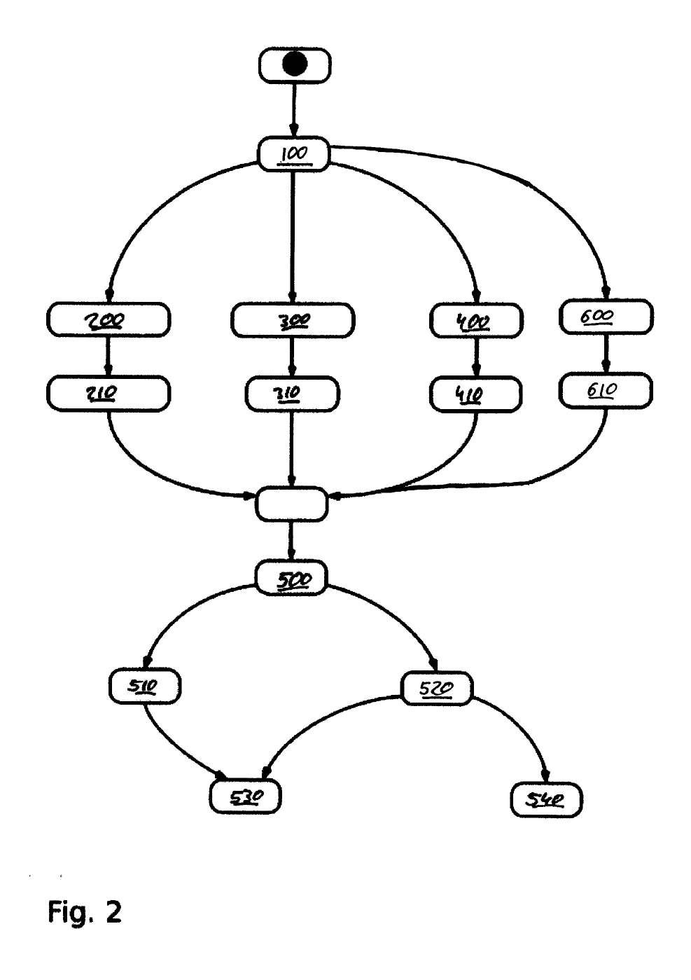

FIG. 2 is a flow chart illustrating the operation of an elevator safety system according to an exemplary embodiment of the invention; and

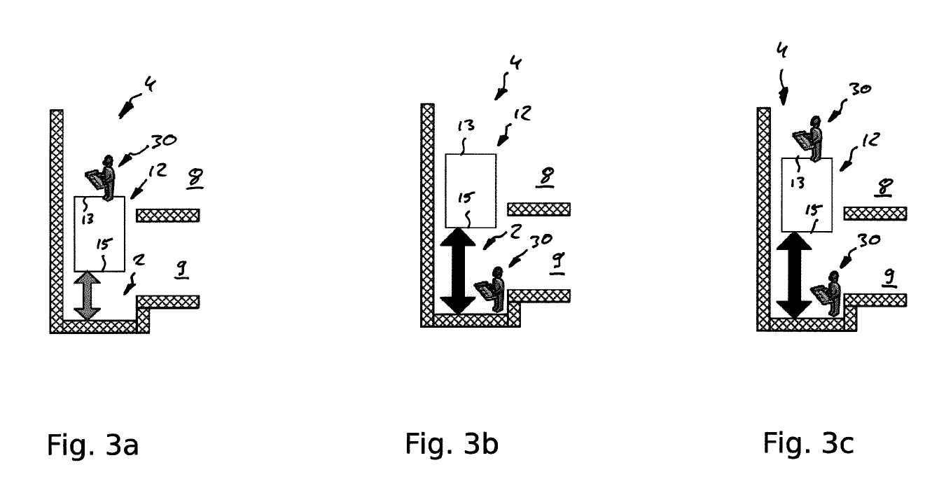

FIGS. 3a to 3c schematically illustrate three different modes of maintenance operation.

FIG. 1 illustrates a schematic view of an elevator system 2 including an elevator safety system according to an exemplary embodiment of the invention.

The elevator system 2 comprises a hoistway 4 extending vertically between a plurality of floors/landings 6, 8, 9.

A landing door 61, 81, 91 providing access to the hoistway 4 and a control panel 62, 82, 92 are arranged at each of the landings 6, 8, 9, respectively.

An elevator car 12 and a corresponding counterweight 14 are movably suspended within the hoistway 4 by means of a tension member 16 allowing the elevator car 12 and the counterweight 14 to move vertically along the hoistway 4 in opposite directions.

The elevator car 12 is provided with at least one elevator car door 20 and an elevator car control panel 22.

The tension member 16 may be a rope, a belt, or a combination of ropes/belts. The tension member 16 extends over a drive sheave 18, which is provided in an upper area of the hoistway 4.

FIG. 1 depicts a simple 1:1 suspension of the elevator car 12. The skilled person, however, will easily understand that different suspensions, such as 2:1, 4:1, 8:1 etc. and similar suspensions, which may include, or may not include, a counterweight 14, may be used in elevator systems 2 according to exemplary embodiments of the invention, as well.

The drive sheave 18 is driven by a drive machine (not shown) comprising a motor, thus forming a traction drive. The motor driving the drive sheave 18 is controlled by an elevator control 28 based on input provided via the control panels 62, 82, 92, 22 according to passengers' requests. Other drive machines than a traction drive are conceivable as well, e.g. linear drives or hydraulic drives.

The elevator car 12 is provided with a position sensor 25, which is configured for providing a position value indicating the current position of the elevator car 12 while moving along the hoistway 4. The elevator car 12 further may be provided with a speed sensor 27, which is configured for providing a speed value indicating the current speed of the elevator car 12 while moving along the hoistway 4.

The position sensor 25 may be configured to determine the current position value by integrating the speed measured by the speed sensor 27 and/or an acceleration, which is measured by an additional acceleration sensor (not shown), over time.

Alternatively or additionally, the position sensor 25 may interact with a wall 5 of the hoistway 4 and/or markers 24, 26, 64, 84, 94, which are provided at the wall 5 of the hoistway 4, in order to determine the current position of the elevator car 12 within the hoistway 4. The position sensor 25 in particular may (re-)calibrate the position value determined by integrating the speed and/or the acceleration of the elevator car 12 over time, every time the position sensor 25 passes one of the markers 24, 26, 64, 84, 94.

In the embodiment shown in FIG. 1, a marker 64, 84, 94 is positioned at each landing 6, 8, 9, respectively. Additional markers 24, are arranged close to the ceiling 11 of the hoistway 4 and within a pit 10, which is formed at the bottom 17 of the hoistway 4, respectively.

The configuration illustrated in FIG. 1, however, is only exemplary. It in particular is not necessary to provide a marker 64, 84, 94 at every landing 6, 8, 9. Further, the markers 64, 84, 94 assigned to the landings 6, 8, 9 may be provided at a different position than the top of the respective landing door 61, 81, 91. In principle, it might be sufficient to provide a single marker 24, 26, 64, 84, 94 at a predefined position within the hoistway 4 in order to (re-)calibrate the position information whenever the elevator car 12 passes said marker 24, 26, 64, 84, 94.

The position information provided by the position sensor 25 may be transmitted to the elevator control 28 by means of a cable (not shown) extending along the hoistway 4, or by means of wireless data transmission.

The elevator control 28 is configured for controlling the movement of the elevator car 12 along the hoistway 4 by driving the drive sheave 18 based on the position information provided by the position sensor 25.

The position sensor 25 and the optional speed sensor 27 are components of the elevator safety system. The elevator safety system further includes a safety chain 40 comprising a plurality of contactors 42, which are configured for monitoring safety relevant functions of the elevator system 2. The elevator safety system in particular is configured to stop any movement of the elevator car 12 if at least one of the contactors 42 of the safety chain 40 is opened.

The elevator safety system further includes a limit setting unit 32 and a comparison unit 34. The limit setting unit 32 and the comparison unit 34 may be integrated in the elevator control 28, as shown in FIG. 1. In an alternative embodiment, which is not shown in the figures, the limit setting unit 32 and the comparison unit 34 may be provided separately from the elevator control 28.

The limit setting unit 32 is configured for determining a current operation status of the elevator car 12 and for setting at least one position limit according to the determined operation status. The limit setting unit 32 may be further configured for setting a speed limit according to the determined operation status.

The comparison unit 34 is configured for comparing the position value, which has been determined by the position sensor 25, with the position limit set by the limit setting unit 32. The comparison unit 34 is configured for determining an unsafe condition, if the determined position value is not in compliance with the at least one position limit.

The comparison unit 34 may be further configured for comparing the speed value, which has been determined by the position sensor 25, with the speed limit set by the limit setting unit 32. The comparison unit 34 may be configured for determining an unsafe condition only if the determined speed value is not in compliance with the speed limit. The comparison unit 34 in particular may be configured to determine that there is no unsafe condition if the elevator car 12 does not move.

FIG. 2 is a flow chart illustrating the operation of an elevator safety system 2 according to an exemplary embodiment of the invention. FIGS. 3a to 3c schematically illustrate three different modes of maintenance operation 200, 300, 400.

In a first step 100, the current operation status of the elevator system 2 is determined. It is in particular determined, whether the elevator system 2 is in a mode of normal operation 600, or in one of a plurality of modes of maintenance operation 200, 300, 400. In the following steps 210, 310, 410, 610 limits for the position of the elevator car 12 are set according to said determined operation status of the elevator system 2.

A first mode of maintenance operation 200 is activated when a person 30 intends to work on top 13 of the elevator car 12 or within the elevator car 12 (see FIG. 3a) reaching out through the top 13 of the elevator car 12. In this first mode of maintenance operation 200, an upper position limit defining the uppermost allowable position of the elevator car 12 within the hoistway 4 is set in step 210 to a value which is smaller than the upper position limit during normal operation. This ensures that sufficient space is provided above the elevator car 12 in order to avoid that the person 30 when working on top 13 of the elevator car 12, or within the elevator car 12 and reaching through the top 13 of the elevator car 12, is squeezed between the top 13 of the elevator car 12 and the ceiling 11 of the hoistway 4.

A second mode of maintenance operation 300 is activated when the person 30 intends to work below the elevator car 12, in particular within the pit 10 of the hoistway (see FIG. 3b). In this second mode of maintenance operation 300, a lower position limit defining the lowermost allowable position of the elevator car 12 within the hoistway 4 is set in step 310 to a value which is larger than the lower position limit during normal operation. This ensures that sufficient space is provided below the elevator car 12 in order to avoid that the person 30, when working below the elevator car 12, in particular within the pit 10, is squeezed between the bottom 15 of the elevator car 12 and the bottom 17 of the hoistway 4.

A third mode of maintenance operation 400 is activated when the person 30 intends to work below the elevator car 12 in particular within the pit 10 of the hoistway and the same or another person 30 intends to work within the elevator car 12 or on top 13 of the elevator car 12 (see FIG. 3c).

In this third mode of maintenance operation 400, the lower position limit is set to a value which is larger than the lower position limit during normal operation in step 410 ensuring that sufficient space is provided below the elevator car 12 in order to avoid that a person 30, when working below the elevator car 12, in particular within the pit 10, is squeezed between the bottom 15 of the elevator car 12 and the bottom 17 of the hoistway 4. Additionally, the upper position limit is set to a value which is smaller than the upper position limit during normal operation ensuring that sufficient space is provided above the elevator car 12 in order to avoid that a person 30, when working on top 13 of the elevator car 12 or working within the elevator car 12 and reaching through the top 13 of the elevator car 12, is squeezed between the top 13 of the elevator car 12 and the ceiling 11 of the hoistway 4. In order words, in the third mode of maintenance operation 400, the range of allowed movement of the elevator car 12 is reduced at both ends, at the lower end (bottom 17) as well as at the upper end (ceiling 11), of the hoistway 4.

If the elevator system 2 is not in any mode of maintenance operation 200, 300, 400, but in a mode of normal operation 600, the upper and lower position limits remain or are set in step 610 to their respective values corresponding to the mode of normal operation 600.

In the mode of normal operation 600, the upper and lower limits are set so that the elevator car 12 does not hit the bottom 17 or the ceiling 11 of the hoistway 4. However, in the mode of normal operation 600, no extra space is needed for accommodating a person 30 between the elevator car 12 and the bottom 17 or the ceiling 11 of the hoistway 4, respectively. In consequence, in the mode of normal operation 600, the elevator car 12 is allowed to move into positions which are very close to the bottom 17 or the ceiling 11 of the hoistway 4, respectively.

In a next step 500, the current position of the elevator car 12 is checked based on the information provided by the position sensor 25.

In case the current position of the elevator car 12, as determined by the position sensor 25, is within the predefined range, which has been set in one of the previous steps 210, 310, 410, 610, the elevator system 2 is in a safe condition and the operation of the elevator system continues (step 530).

However, if the current position of the elevator car 12 is not within the predefined range, the elevator system 2 may be in an unsafe condition jeopardizing the health of a person 30 working below, within or above the elevator car 12.

In a simple embodiment, which is not illustrated in the figures, the elevator safety system may be configured to stop any further movement of the elevator car 12 whenever it is determined that the current position of the elevator car 12 is not within the predefined range.

In the embodiment depicted in FIG. 2, however, in case it is determined that the current position of the elevator car 12 is not within the predefined range, the information provided by the speed sensor 27 is evaluated in order to check whether the elevator car 12 is moving, and if it is determined that the elevator car 12 is moving, the direction of the movement is determined (step 520).

In case the elevator car 12 is not moving, there is no risk for the person 30 and normal operation continues (step 530).

If the elevator car 12 is moving, but it is moving out of the “forbidden zone”, i.e. the elevator car 12 is moving upwards, when it is determined to be positioned below the lower limit, or the elevator car 12 is moving downwards, when it is determined to be positioned above the upper limit, there also is no risk that the person 30 is hit or squeezed by the elevator car 12. In consequence, in this case the operation of the elevator system 2 continues (step 530), too.

However, if it is determined that the elevator car 12 moves further into the “forbidden zone”, i.e. the elevator car 12 is moving downwards, when it is determined to be positioned below the lower limit, or the elevator car 12 is moving upwards, when it is determined to be positioned above the upper limit, there is a considerable risk that a person 30 working below, within or above the elevator car 12 is hit and/or squeezed by the moving elevator car 12.

Therefore, in this case at least one of the contactors 40 is opened (step 540) interrupting the safety chain 42 and preventing any further movement of the elevator car 12.

During normal and maintenance operation of the elevator system 2, the steps shown in FIG. 2 are continuously repeated; i.e. after reaching step 530, the procedure starts all over again with determining the current operation status of the elevator system 2 (step 100).

A number of optional features are set out in the following. These features may be realized in particular embodiments, alone or in combination with any of the other features.

According to one embodiment, any movement of the elevator car may be stopped, when an unsafe condition of the elevator system is determined. In order to stop any movement of the elevator car, a safety chain of the elevator system may be interrupted. Interrupting the safety chain of the elevator system results in an immediate stopping of the elevator car. This reliably prevents a person which is on top or below the elevator car from being hit or squeezed by the elevator car.

According to one embodiment, the operation statuses of the elevator system may comprise a status of normal operation and at least one status of maintenance operation. The at least one status of maintenance operation may include a status in which a person enters or reaches into the hoistway. Thus, in the at least one status of maintenance operation, appropriate measures are necessary in order to ensure the safety of the person when accessing the hoistway.

In the status of normal operation, an upper position limit defining the allowed uppermost position of the elevator car and/or a lower position limit defining the allowed lowermost position of the elevator car are respectively set to predetermined values corresponding to the status of normal operation.

According to one embodiment, the at least one status of maintenance operation may include a first mode of maintenance operation, which is activated when the person intends to work within the elevator car or on top of the elevator car. In said first mode of maintenance operation, an upper position limit defining the allowed uppermost position of the elevator car may be set to a value which is smaller than the upper position limit during normal operation. This ensures that sufficient space is provided above the elevator car in order to avoid that the person working on top of the elevator car or working within the elevator car and reaching through the roof of the elevator car is squeezed between the top of the elevator car and the ceiling of the hoistway when the elevator car moves upwards.

According to one embodiment, the at least one status of maintenance operation may include a second mode of maintenance operation, which is activated when the person intends to work below the elevator car, in particular within the pit of the hoistway. In this second mode of maintenance operation, a lower position limit defining the allowed lowermost position of the elevator car may be set to a value which is larger than the lower position limit during normal operation. This ensures that sufficient space is provided above the elevator car in order to avoid that the person working below the elevator car, in particular within the pit of the hoistway, is squeezed between the bottom of the elevator car and the bottom of the hoistway when the elevator car moves downwards.

According to one embodiment, the at least one status of maintenance operation may include a third mode of maintenance operation, which is activated when a person intends to work below the elevator car, in particular within the pit of the hoistway, and the same or another person intends to work within the elevator car or on top of the elevator car.

In this third mode of maintenance operation, the lower position limit may be set to a value which is larger than the lower position limit during normal operation for ensuring a sufficient space above the elevator car in order to avoid a person working below the elevator car, in particular within the pit, from being squeezed between the bottom of the elevator car and the bottom of the hoistway. Additionally, the upper position limit may be set to a value which is smaller than the upper position limit during normal operation for ensuring a sufficient space above the elevator car in order to avoid that a person working on top of the elevator car or working within the elevator car and reaching through the roof of the elevator car is squeezed between the top of the elevator car and the ceiling of the hoistway.

According to one embodiment, the elevator safety system may further comprise a speed sensor, which is configured for determining a speed value representing the speed and the direction of the movement of the elevator car within the hoistway. Additionally, the comparison unit may be configured for determining an unsafe condition of the elevator system only if the speed value exceeds a predetermined speed limit. This avoids determining an unsafe condition of the elevator system in case the elevator car does not move or moves only with a slow speed, which does not cause any danger for the person working within the hoistway.

According to one embodiment, the comparison unit may be configured for determining an unsafe condition of the elevator system in case an upper position limit is exceeded or a lower position limit is undercut only if the elevator car is commanded to move in a predetermined direction, in particular in a direction which increases the difference between the position of the elevator car and the exceeded upper position limit or undercut lower position limit, respectively. As a result, the operation of the elevator system is interrupted if the elevator car moves further into the “forbidden zone” decreasing the space which is available for the person, but the operation of the elevator system is not interrupted if the elevator car moves away from the person, as such a movement does not jeopardize the person.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system
4 hoistway
5 wall of the hoistway
6, 8, 9 floors/landings
10 pit
11 ceiling of the hoistway
12 elevator car
13 top of the elevator car
14 counterweight
15 bottom of the elevator car
16 tension member
17 bottom of the hoistway
18 drive sheave
20 elevator car door
22 elevator car control panel
24 marker
25 position sensor
26 marker
27 speed sensor
28 elevator control
30 person
32 limit setting unit
34 comparison unit
40 safety chain
42 contactor
61, 81, 91 landing door
64, 84, 94 marker
100 determining the current operation status of the elevator car
200 first mode of maintenance operation
210 setting a position limit for first mode of maintenance operation
300 second mode of maintenance operation
310 setting a position limit for second mode of maintenance operation
400 third mode of maintenance operation
410 setting a position limit for third mode of maintenance operation
500 checking the current position of the elevator car
510 determining that the elevator system is in a safe condition
520 checking the speed and direction of the movement of the elevator car
530 continuing normal operation of the elevator system
540 determining that the elevator system is in an unsafe condition/opening the safety chain
600 mode of normal operation
610 setting a position limit for mode of normal operation

1. An elevator safety system for an elevator system (2) with an elevator car (12), which is movable along a hoistway (4), wherein the elevator safety system comprises:
at least one position sensor (25), which is configured for determining a position value representing the position of the elevator car (12) within the hoistway (4);
a limit setting unit (32), which is configured for determining an operation status of the elevator system (2) and for setting at least one position limit according to the determined operation status of the elevator system (2);
a comparison unit (34), which is configured for comparing the position value with the at least one position limit and for determining an unsafe condition of the elevator system (2) if the position value is not in compliance with the at least one position limit.

2. The elevator safety system according to claim 1, wherein the operation statuses of the elevator system (2) comprise at least one status of normal operation and at least one status of maintenance operation.

3. The elevator safety system according to claim 2, wherein the at least one position limit includes an upper position limit for the position of the elevator car (12) within the hoistway (4) which is set to a predetermined value in normal operation, and wherein the at least one status of maintenance operation comprises a first status of maintenance operation, in which the upper position limit is set to a value which is smaller than the upper position limit in normal operation.

4. The elevator safety system according to claim 2, wherein the position limit includes a lower position limit for the position of the elevator car (12) within the hoistway (4) which is set to a predetermined value in normal operation, and wherein the at least one status of maintenance operation comprises a second status of maintenance operation, in which the lower position limit is set to a value which is larger than the lower position limit in normal operation.

5. The elevator safety system according to claim 2, wherein the at least one position limit includes a lower position limit and an upper position limit for the position of the elevator car (12) within the hoistway (4) which are set to predetermined values in normal operation, respectively, and wherein the at least one status of maintenance operation comprises a third status of maintenance operation, in which the upper position limit is set to a value which is smaller than the upper position limit in normal operation, and in which the lower position limit is set to a value which is larger than the lower position limit in normal operation.

6. The elevator safety system according to claim 1 further comprising a speed sensor (27), which is configured for determining a speed value representing the speed and direction of the movement of the elevator car (12) within the hoistway (4).

7. The elevator safety system according to claim 6, wherein the comparison unit (34) is configured for determining an unsafe condition of the elevator system (2) only if the speed value exceeds a predetermined speed limit.

8. The elevator safety system according to claim 6, wherein the comparison unit (34), in case an upper position limit position limit is exceeded or a lower position limit is undercut, is configured to determine an unsafe condition of the elevator system (2) only if the elevator car (12) is commanded to move in a predetermined direction, in particular in a direction which increases the difference between the position of the elevator car (12) and the exceeded upper position limit or undercut lower position limit, respectively.

9. An elevator system (2) comprising an elevator car (12), which is movable along a hoistway (4), and an elevator safety system according to claim 1.

10. A method of monitoring an elevator system (2) comprising an elevator car (12), which is movable along a hoistway (4), wherein the method includes:
determining the operation status of the elevator system (2) and setting at least one upper or lower position limit as a function of the operation status of the elevator system (2);
determining a position value representing the position of the elevator car (12) within the hoistway (4);
comparing the determined position value with the at least one position limit; and
determining an unsafe condition of the elevator system (2), if the position value exceeds an upper position limit or undercuts a lower position limit.

11. The method according to claim 10, wherein the elevator system (2) further comprises a speed sensor (27), which is configured for determining a speed value representing the speed of the elevator car (12) when moving within the hoistway (4), and wherein an unsafe condition of the elevator system (2) is determined only if the speed value exceeds a predetermined speed limit.

12. The method according to claim 10, wherein an unsafe condition of the elevator system (2) is determined if the elevator car (12) is commanded to move in a predetermined direction, in particular in a direction which increases the difference between the position of the elevator car (12) and an exceeded upper position limit or an undercut lower position limit.

13. The method according to claim 10, wherein the at least one position limit includes an upper position limit for the position of the elevator car (12) within the hoistway (4) which is set to a predetermined value in normal operation, and wherein at least one status of maintenance operation comprises a first status of maintenance operation, in which the upper position limit is set to a value which is smaller than the upper position limit in normal operation.

14. The method according to claim 10, wherein the at least one position limit includes a lower position limit for the position of the elevator car (12) within the hoistway (4) which is set to a predetermined value in normal operation, and wherein the at least one status of maintenance operation comprises a second status of maintenance operation, in which the lower position limit is set to a value which is larger than the lower position limit in normal operation.

15. The method according to claim 10, wherein the at least one position limit includes a lower position limit and an upper position limit for the position of the elevator car (12) within the hoistway (4) which are set to predetermined values in normal operation, respectively, and wherein the at least one status of maintenance operation comprises a third status of maintenance operation, in which the upper position limit is set to a value which is smaller than the upper position limit in normal operation, and in which the lower position limit is set to a value which is larger than the lower position limit in normal operation.
